(19) United States
(12) Patent Application Publication
(10) Pub. No.: US 2026/0015901 A1
(43) Pub. Date: Jan. 15, 2026

(54) INTEGRAL LOCKING APPARATUS USING ROTATIONAL FORCE INFLECTION AND METHODS OF USE THEREOF

(71) Applicant: FLACKTEK SPEEDMIXER, INC., LANDRUM, SC (US)

(72) Inventors: JAMES EMANUEL EARLE, LONGMONT, CO (US); MICHAEL GARRISON DREW SCHLABACH, BROOMFIELD, CO (US); ADAM THOMAS MIRABILE, BROOMFIELD, CO (US)

(21) Appl. No.: 18/993,841

(22) PCT Filed: Jul. 12, 2023
(86) PCT No.: PCT/US2023/027514

§ 371 Date: Jan. 13, 2025

Related U.S. Application Data
(60) Provisional application No. 63/388,399, filed on Jul. 12, 2022.

(51) Int. Cl. E05F 15/63; B01F 29/15; B01F 35/45

(52) U.S. Cl. CPC B01F 35/451; B01F 29/15

(57) ABSTRACT

The invention includes a locking apparatus adapted to use rotational force inflection as an integral locking mechanism, and in particular an integral locking mechanism for the lid of an asymmetrical rotational mixer.

### CROSS-REFERENCE TO RELATED APPLICATIONS

This International PCT application claims the benefit of and priority to U.S. Provisional Application No. 63/388,399 filed Jul. 12, 2022, the specification, claims, and drawings of which are incorporated herein by reference in their entirety.

### TECHNICAL FIELD

Generally, the inventive technology disclosed herein relates to a locking apparatus, and in particular a locking apparatus adapted to use rotational force inflection as an integral locking mechanism.

### BACKGROUND OF THE INVENTION

Locking mechanisms are well known in the art and have been incorporated into a number of technologies and mechanical applications. Traditional off-the-shelf lock mechanisms, similar to those found in car doors employ a system of rotary latches, and are commonly used for their strength and reliability. However, for certain mechanical applications such traditional rotary latch-based locks are inadequate. For example, high-precision mechanical equipment often requires strong locking mechanisms that must also be engineered to be significantly smaller than traditional locking mechanisms. Moreover, traditional rotary latches rely on a gas spring for the opening mechanism of the lid, which is difficult to automate, while the adjustability of a traditional rotary latch are not sufficient to keep the lid closed and secured for many devices.

In one example described below, the assembly process for adapting traditional rotary latches to a standard dual asymmetrical centrifugal mixing device (DAC) is extremely complicated and not repeatable. Finally, contrary to simple door locks, many mechanical devices require a frequency of use that renders most traditional locking apparatus inoperable. Indeed, even the smallest of rotary latch systems are commonly only rated to 20,000-100,000 operations, while many industrial and high-tech applications require a rating that greatly exceeds this number.

Prior attempts in the art to address the above concerns have been inadequate. In one example, the lid of an exemplary DAC was secured using a traditional off-the-shelf lock body that used a “key” that extended from the bottom of the lid. (FIG. 1) While initially effective at securing the lid, the design included significant technical disadvantages. For example, as shown in FIG. 1A, the holes in the top of the machine allowed for material ingress to the enclosure, such that the keys could harm the user if the gas spring (A) that held the lid in place failed. Moreover, this design could not be configured to be tamper resistant, and could be operated in an unsafe manner where the key could be removed and left inside the lock body. As further shown in FIG. 1, in this traditional design the lid could not reach a 90° vertical position relative to the mixer body and under its own power (See angle B of FIG. 1).

As such, there exists a long-felt need for an improved locking assembly that be operated automatically, is tamper resistant, can be adapted to open a corresponding lid or cover to approximately 90°, and where all of the lock mechanics can be self-contained inside the device and not exposed to the end user of the machine.

### SUMMARY OF INVENTION

In one aspect, the invention includes a lock, and preferably an integral locking apparatus that manipulates the infection point of the axis of rotation of a circular rotational gear assembly to secure the device in a desired position. In a preferred aspect, the locking assembly of the invention may be used for devices that require frequent opening and closing of a lid or other similar cover. Exemplary devices may include a DAC as defined herein.

In another aspect, the rotational lock assembly of the invention can be operated automatically or manually, and can be tamper resistant. In another aspect, the rotational lock assembly of the invention can open a lid or other similar cover to approximately 90° from a horizontally closed position, and all of the lock assembly components can be self-contained inside the device.

In another aspect, the invention includes a lock assembly having a rotating shaft responsive to a motor that may be mounted to a bracket. The rotating shaft may apply a forward or reverse rotational force to a rotational gear assembly, which in a preferred aspect includes a first spur gear responsive to the rotating shaft, and a second spur gear responsive to the first spur gear and coupled with a support shaft. A driving linkage can be coupled with the second spur gear and further coupled with a connector, which can be secured to a lid or other similar cover. In this preferred aspect, activation of the motor applies a forward or reverse rotational force to the rotational gear assembly causing the driving linkage and connector to move synchronously in the direction of the rotational force causing a responsive lid into an open or closed position, respectively.

In a further aspect, when an exemplary lid is in a closed position, the motor may further apply a reverse rotational force to the rotational gear assembly causing the driving linkage, at the point where it is coupled to the second spur gear, to be aligned at or past the axis of rotation. In this configuration, the driving linkage is further physically impeded by being positioned against the support shaft preventing further reverse movement of the rotational gear assembly thereby locking the lid in its closed position.

Additional aspects of the invention may become evident based on the specification and figures presented below.

### BRIEF DESCRIPTION OF THE DRAWINGS

FIG. 1 shows a traditional rotary latch locking device used to raise and lower the lid of an exemplary DAC;

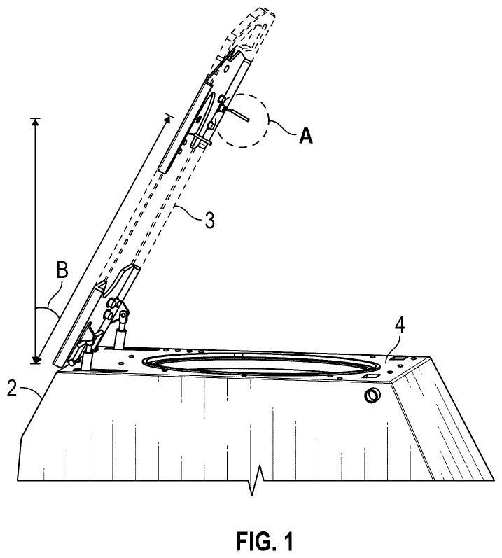

FIG. 2 shows a schematic of the force applied to a rotating circular body, including the central axis of rotation;

FIG. 3 shows a rotational locking assembly having a motor responsive to a pair of spur gears that are responsive to a driving linkage coupled with a connector in one embodiment thereof;

FIG. 4 shows a rotational lock having a motor responsive to a rotational gear assembly that is responsive to a driving linkage coupled with a connector as well as a spring opening assembly in one embodiment thereof;

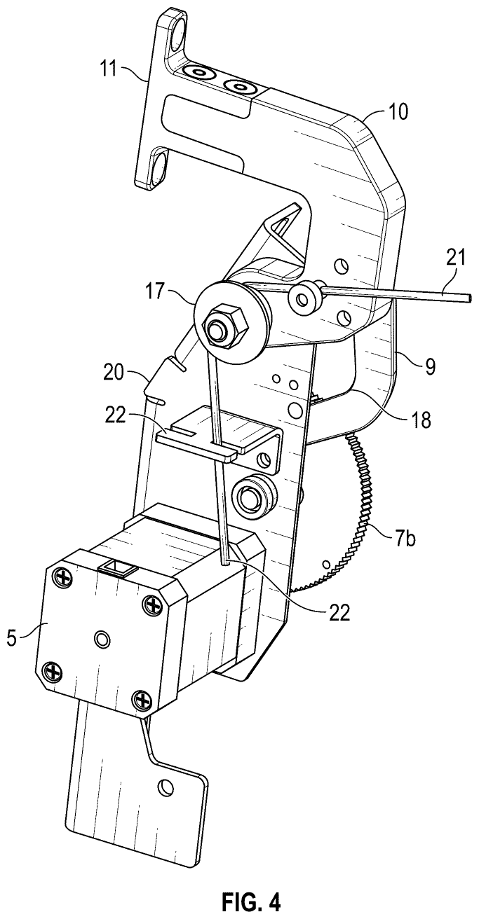

FIG. 5 shows an isolated view of a pair of spur gears mounted to a bracket that are responsive to a driving linkage coupled with a connector in one embodiment thereof;

FIG. 6 shows an isolated view of a rotational gear coupled with a driving linkage that is further secured to a connector, wherein the distal end of the driving linkage is positioned at or beyond the axis of rotation and further positioned against a support shaft preventing reverse movement of the rotational gear assembly thereby locking the rotational gear and associated components in one embodiment thereof;

FIG. 7 shows a pair of rotational locking assemblies positioned within the internal portion of an exemplary DAC and responsive to a lid component in one embodiment thereof;

### DETAILED DESCRIPTION OF THE INVENTION

The present invention includes a variety of aspects, which may be combined in a variety of different ways. The following descriptions are provided to list elements and describe certain preferred embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

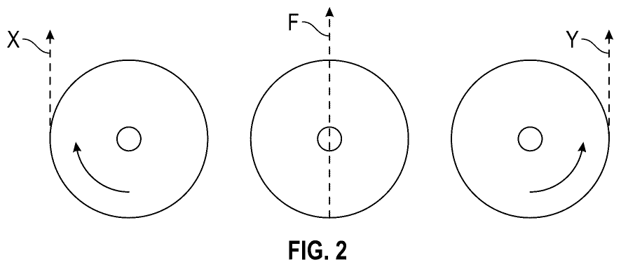

It is a commonly understood principal that a rotating object, when positioned on an axis will rotated in the direction of the force applied to the object. As highlighted in in FIG. 2, when an exemplary force, being identified herein as a forward force (X) is applied a rotating object, it will move in a forward direction. Conversely, when an opposite exemplary force, being identified herein as a reverse force (Y) is applied a rotating object, it will move in a reverse direction. Notably, as further highlighted in FIG. 2, when the force applied to the rotating object is in line with the axis of rotation (F), the object will not rotate as there is no rotary force applied. As used herein, the “axis of rotation” means the straight line through all fixed points of a rotating rigid body around which all other points of the body move in circles. Based on these principles of the movement of rotating rigid bodies, the present inventors sought to develop an improved rotational locking assembly that manipulates the force applied to a rotational gear to allow forward and reverse movement, while further allowing the rotational gear of the invention to be positioned in a locked configuration without a traditional locking mechanism to physically block the movement of the rotational gear.

As generally described below, the rotational locking assembly of the invention can be secured to a lid or other similar movable cover or surface and used to apply a forward or reverse force to open or close the lid, respectively. For example, a motor, or other similar device can apply a forward or reverse rotational force to a rotational gear assembly of the invention causing a corresponding lid or other cover to be opened or closed, respectively. When the lid is in a closed position, a motor can apply an reverse rotational force to the rotational gear assembly such that the terminal position, being the position where a driving linkage and rotational gear are coupled, is positioned at or past the axis of rotation. In this configuration, any force applied to the lid, for example by a user attempting to open the lid, would generate a force that is transmitted through the driving linkage to the rotational gear. However, as described below, because the terminal position of the driving linkage is positioned at or beyond the axis of rotation, the force transmitted from the driving linkage will be applied to the rotational gear at a vector such that it would rotate in a reverse direction or not rotate at all.

As further described below, the driving linkage is physically restrained in this configuration, such that further reverse rotational movement of the rotational gear is impeded, thereby locking the gear and corresponding lid in place. Thus, with the rotational gear locked in this manner, a user cannot force the lid open, as the force vectors applied to the rotational gear and physical restraint of the driving linkage will prevent it. As a result, the present inventors have invented a novel locking mechanism that relies only on the physics of the integral pieces and their design.

As further described below, the rotational locking assembly can be unlocked, by applying a forward rotational force to the rotational gear causing the terminal position to traverse back across axis or rotation, at which point the force vector generated by the opening of a lid, or continued forward rotational movement of the motor, is applied to the “correct” side of the gear's axis of rotation, allowing the gear to rotate freely and a coupled lid to move freely. In one aspect, a sensor can be positioned to detect the gear position and communicate with a controller that can further be responsive to a motor allowing automatic control of the lid opening and closing procedures. The sensor of the invention can further be configured to detect if the lid is closed and locked as well as a stop point when the lid is partially or completely open. A spring assembly can further be used to provide a mechanical assist to the lid.

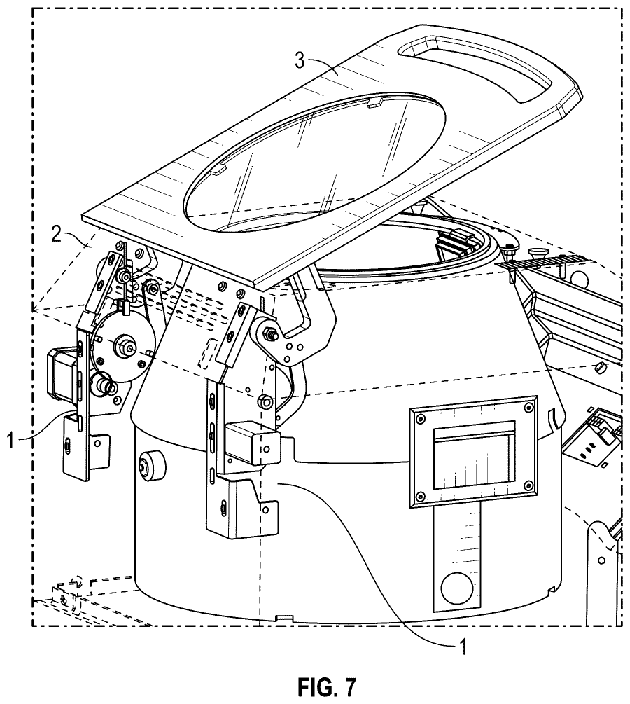

The present invention includes systems, methods, and apparatus for a novel rotational lock assembly (1), also sometimes referred to herein as a lock assembly (1). The rotational lock assembly (1) may be coupled with a lid (3), or other similar cover or movable surface and allows for movement of the same. As shown in FIG. 7, one, or a plurality of rotational lock assemblies (1) can be used to regulate the movement of the lid (3) of an asymmetrical rotational mixer (2) (also referred to herein as a DAC) or other similar device that requires a large number of repeatable movements of a lid or other similar cover. In this preferred embodiment, a pair of rotational lock assemblies (1) can be positioned within the internal compartment of an asymmetrical rotational mixer (2) and coupled with the lid (3) and further be configured to allow the lid (3) to be automatically closed, opened, and preferably open to approximately 90° degrees from a horizontal closed position. In the preferred embodiment shown in the Figures, a pair of rotational lock assemblies (1) can be positioned within the internal compartment of an asymmetrical rotational mixer (2) and coupled with the lid (3) to allow the lid (3) to be automatically locked into position so as to be tamper resistant as described below.

The rotational lock assembly (1) of the invention may include a motor (5). In a preferred embodiment, the motor (5) of the invention may be mounted to a bracket (20) and positioned within the internal compartment of a device, such as an asymmetrical rotational mixer (2). As used herein, a motor (5) of the invention can include any device or apparatus that can generate a rotational force, and may be selected from the group consisting of: an electric motor, a servo motor, a hydraulic motor, a combustion motor, or a pneumatic motor. In alternative embodiments, a rotational force can be generated manually, for example by a user.

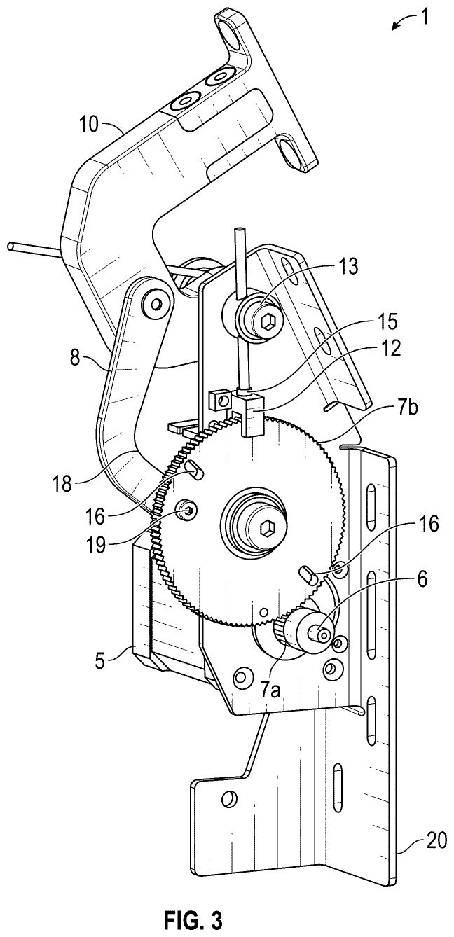

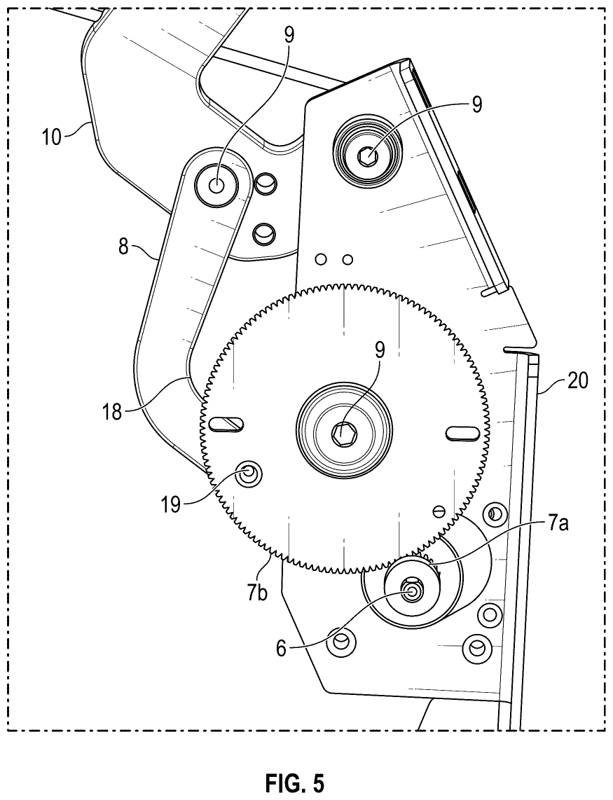

As shown in FIG. 3, the motor (5) of the invention is coupled with a rotating shaft (6), such as an axle that can rotate in a forward or reverse direction in response to the action of the motor (5). The rotating shaft (6) of the invention, being responsive to the motor (5), transmits the rotational force generated by the motor (5) to a rotational gear assembly (7). In one embodiment, the rotational gear assembly (7) of the invention includes one or a pair of rotational gears, which may, in an embodiment include a pair of spur gears (7a, 7b) responsive to one another. As shown in the preferred embodiment of FIGS. 3 and 5, a first spur gear (7a) may be coupled with the rotating shaft (6) such that is rotates in the same direction as the shaft (6). The first spur gear (7a) may be coupled with a second spur gear (7b) through a series of teeth such that the rotational force generated by the motor (5) is transmitted to the rotating shaft (6) and coupled first spur gear (7a) to the second spur gear (7b) causing it to rotate in a forward or backward direction. Naturally, the ratio of the first and second rotational gears can be adjusted based on the user's desire or gearing requirements for certain applications.

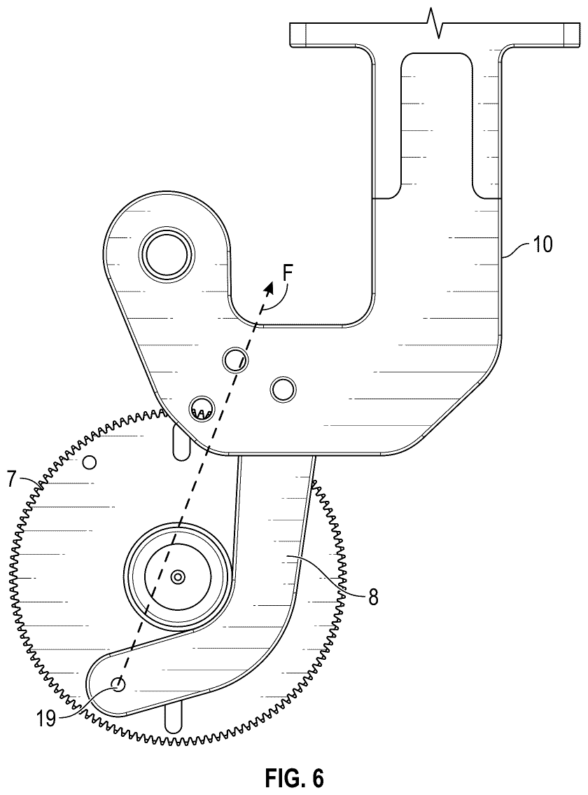

The rotational lock assembly (1) of the invention includes a driving linkage (8). In a preferred embodiment, the driving linkage (8) of the invention is coupled to a rotational gear of a rotational gear assembly (7). As shown in FIG. 6, the driving linkage (8) of the invention is coupled with the second spur gear (7b) of an exemplary rotational gear assembly (7) at a terminal position (19). As shown in FIG. 6, the a terminal position (19) of the invention may be positioned: 1) in a forward position in relation to the axis or rotation (F) such that a force, being referred to as a forward rotational force (X), will cause the forward rotation of the second spur gear (7b); 2) in a reverse position in relation to the axis or rotation (F) such that a force, being referred to as a reverse rotational force (Y), will cause the reverse rotation of the second spur gear (7b); or 3) aligned with the axis or rotation (F) such that a force, being generally described as a rotational force applied along the axis will not allow the reverse or forward rotation of the second spur gear (7b).

The driving linkage (8) of the invention can be further coupled with a connector (10). In this configuration, rotational movement of the rotational gear assembly (7) causes the driving linkage (8) and connector (10) to traverse in a pre-determined linear direction. The connector (10) of the invention can be secured to a lid (3) or other similar cover or movable components or surface, for example by a cover mount (11) further secured by one or more fastener (9). In this preferred embodiment, activation of a motor (5) applies a forward or reverse rotational force to the rotational gear assembly (7) causing the driving linkage (8) and connector (10) to move synchronously in the direction of the rotational force causing the lid (3) into an open or closed position, respectively. Specifically, in this configuration, a forward rotational movement of the rotational gear assembly (7) causes the driving linkage (8) and connector (10) to extend in a linear direction causing the corresponding lid (3) to move into a vertical open position. Conversely, in this configuration, a reverse rotational movement of the rotational gear assembly (7) causes the driving linkage (8) and connector (10) to retract in a linear direction causing the corresponding lid (3) to move into a horizontal closed position.

The rotational lock assembly (1) of the invention includes a novel integral locking operation. In a preferred embodiment, when a rotational gear assembly (7) and/or lid (3) is in a closed position, a motor (5) is adapted to apply a reverse rotational force to the rotational gear assembly (7) causing the driving linkage (8), which in a preferred embodiment is coupled with a second spur gear (7b), to be aligned at or past the axis of rotation (F), and specifically the terminal position (19) is placed at or past the axis of rotation (F). As further shown in FIG. 6, in this configuration, the spur (18) of the driving linkage (8) is also positioned against a support shaft (14) preventing further reverse movement of the rotational gear assembly (8) thereby locking the lid (3) and/or gear assembly (7).

The rotational lock assembly (1) of the invention includes a novel integral unlocking operation. In a preferred embodiment, when a rotational gear assembly (7) and/or lid (3) is in a closed position, a motor (5) is adapted to apply a forward rotational force to the rotational gear assembly (7) causing the driving linkage (8), which in a preferred embodiment is coupled with a second spur gear (7b), to be aligned in front of the axis of rotation (F), and specifically the terminal position (19) is placed in front of the axis of rotation (F). In this configuration, forward movement of said rotational gear assembly (1), generated manually or preferably by a motor (5), causes the lid (3) to be unlocked, and move to an open position, and preferably at least 90° degrees from its closed horizontal position.

The rotational lock assembly (1) of the invention can further include a sensor (12). A sensor (12) of the invention may be mounted to a bracket (20) and positioned adjacent to a rotational gear assembly (7), and preferably a second spur gear (7b). In this configuration, the sensor (12) is adapted detect the position of the rotational gear assembly (7). As shown in FIG. 3, the sensor (12) of the invention can include an optical sensor (12) secured to a sensor mount (13) and further adapted to identify one or more gear apertures (16) in the second spur gear (7a) so as to detect the position of the rotational gear assembly (7). In this configuration, the position of the rotational gear assembly (7) can be communicated by the sensor (12) through a wired, or wireless signal to a controller (15), having a processor that is adapted to run a computer executable program to control the activation, speed, and direction of the rotational force output by the motor (5). The controller (15) of the invention may be responsive to a user, for example through an interface such as an interactive control panel or pre-determined computer executable program for an opening or closing program that can be automatically or manually initiated.

In another preferred embodiment, the invention may further include a spring opening assembly (17), having a torsion spring (21) coupled with the connector, and a spring block (22) coupled to the bracket, which provides a mechanical assist in the lid opening operation.

As noted above, certain steps as herein described may be accomplished in some embodiments through any appropriate controller (15), having a processor, which may include device resulting in the transformation of, for example data, data processing, data transformation, external devices, operations, and the like. It should also be noted that in some instance's software and/or software solution may be utilized to carry out the objectives of the invention and may be defined as software stored on a magnetic or optical disk or other appropriate physical computer readable media including wireless devices and/or smart phones. In alternative embodiments the software and/or data structures can be associated in combination with a computer or processor that operates on the data structure or utilizes the software. Further embodiments may include transmitting and/or loading and/or updating of the software on a computer perhaps remotely over the internet or through any other appropriate transmission machine or device, or even the executing of the software on a computer resulting in the data and/or other physical transformations as herein described.

Certain embodiments of the inventive technology may utilize a machine and/or device which may include a general purpose computer, a computer that can perform an algorithm, computer readable medium, software, computer readable medium continuing specific programming, a computer network, a server and receiver network, transmission elements, wireless devices and/or smart phones, internet transmission and receiving element; cloud-based storage and transmission systems, software updateable elements; computer routines and/or subroutines, computer readable memory, data storage elements, random access memory elements, and/or computer interface displays that may represent the data in a physically perceivable transformation such as visually displaying said processed data. In addition, as can be naturally appreciated, any of the steps as herein described may be accomplished in some embodiments through a variety of hardware applications including a keyboard, mouse, computer graphical interface, voice activation or input, server, receiver and any other appropriate hardware device known by those of ordinary skill in the art.

Naturally, all embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves systems, methods, techniques as well as devices to accomplish an integral rotational locking assembly. In this application, the methods and apparatus for the aforementioned systems are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system. In this application, the techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention may be described in some instances in method-oriented terminology, each element of the claims corresponds to a device and vice versa. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms--even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “couple” should be understood to encompass disclosure of the act of “coupling”—whether explicitly discussed or not—and, conversely, were there effectively disclosure of the act of “coupling”, such a disclosure should be understood to encompass disclosure of a “coupling method and/or technique, and/or device.” Such changes and alternative terms are to be understood to be explicitly included in the description.

Any patents, publications, or other references mentioned in this application for patent, such as in the specification or an IDS are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the methods and/or apparatus for providing an integral rotational locking assembly as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that this application also provides support for any combination of elements in the claims and even incorporates any desired proper antecedent basis for certain claim combinations such as with combinations of method, apparatus, process, and the like claims.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and

Description (including the following: for example, the process according to any claims and further comprising any of the steps as shown in any Figures, separately, in any combination or permutation).

Finally, Applicant reserves the right to seek additional design patent protections over the claimed invention; such that the drawings are fully enabled so as to allow one of ordinary skill in the art to know that the claimed design was in Applicant's possession at the time of filing. As such, it should be noted that any broken lines are to be included for the purpose of illustrating environmental matter and form no part of the claimed design should such become necessary.

1. A lock assembly comprising:
a rotating shaft responsive to a motor;
a rotational gear assembly having:
a first spur gear responsive to said rotating shaft;
a second spur gear responsive to said first spur gear and coupled with a support shaft;
a driving linkage coupled with said second spur gear;
a connector coupled with said driving linkage;
a lid coupled with connector;
wherein activation of said motor applies a forward or reverse rotational force to said rotational gear assembly causing said driving linkage and connector to move synchronously in the direction of said rotational force causing the lid into an open or closed position, respectively; and
wherein when said lid is in a closed position, said motor is further adapted to apply a reverse rotational force to said rotational gear assembly causing said driving linkage coupled with said second spur gear to be aligned at or past the axis of rotation, and wherein the spur of said driving linkage is positioned against said support shaft preventing further reverse movement of the rotational gear assembly thereby locking said lid.

2. The lock assembly of claim 1, wherein when said lid is in a closed position, said motor is further adapted to apply a forward rotational force to said rotational gear assembly causing said driving linkage coupled with said second spur gear to cross the axis of rotation causing the forward movement of said second spur gear causing said lid to be unlocked.

3. The lock assembly of claim 1, further comprising a bracket adapted to mount said rotational lock.

4. The lock assembly of claim 1, further comprising a sensor.

5. The lock assembly of claim 4, wherein said sensor comprises an optical sensor adapted to identify one or more gear apertures in said second spur gear.

6. (canceled)

7. The lock assembly of claim 1, further comprising a spring opening assembly.

8. The lock assembly of claim 1, wherein said spring opening assembly comprises:
a torsion spring coupled with said connector; and
a spring block coupled to said bracket.

9. The lock assembly of claim 1, wherein said lid comprises a lid for an asymmetrical rotational mixer.

10. The lock assembly of claim 1, wherein said lid is extended at least 90° degrees from its closed horizontal position.

11-12. (canceled)

13. The lock assembly of claim 1, wherein said rotational gear assembly is responsive to the application of a manual rotational force.

14. A rotational lock comprising:
a motor;
a rotating shaft responsive to said motor;
a rotational gear responsive to said rotating shaft;
a driving linkage coupled with said rotational gear;
a connector coupled with said driving linkage; and
wherein said motor is adapted to apply a reverse rotational force to said rotational gear causing the said driving linkage coupled with said rotational gear to be aligned at or past the axis of rotation and further secured past said axis so as to prevent additional reverse movement thereby locking said rotational gear;
wherein when said rotational gear is in a locked position, said motor is further adapted to apply a forward rotational force to said rotational gear causing said driving linkage to cross the axis of rotation causing said rotational gear to be unlocked; and
wherein said rotational gear comprises rotational gear assembly having a first spur gear responsive to said rotating shaft and a second spur gear responsive to said first spur gear and coupled with a support shaft.

15. The rotational lock of claim 14, wherein activation of said motor applies a forward or reverse rotational force to said rotational gear causing said driving linkage and connector to move synchronously in the direction of said rotational force causing a lid into an open or closed position, respectively.

16. The rotational lock of claim 15, further comprising a lid coupled with said connector.

17. The rotational lock of claim 15, further comprising a cover mount coupling said lid and said connector.

18. The rotational lock of claim 15, wherein said lid comprises a lid for an asymmetrical rotational mixer.

19. he rotational lock of claim 15, wherein said lid is extended at least 90° degrees from its closed horizontal position.

20-21. (canceled)

22. The rotational lock of claim 14, further comprising a bracket adapted to mount said rotational lock.

23. The rotational lock of claim 14, further comprising a sensor.

24-25. (canceled)

26. The rotational lock of claim 14, further comprising a spring opening assembly.

27. The rotational lock of claim 26, spring opening assembly comprises:
a torsion spring coupled with said connector; and
a spring block coupled to said bracket.

28-59. (canceled)
